(19) United States
(12) Patent Application Publication
(10) Pub. No.: US 2020/0294426 A1
(43) Pub. Date: Sep. 17, 2020

(54) Self-adhesive label, comprising a handle and a method of fabrication

(71) Applicant: Poliweb Graphics s.r.l., Gossolengo (PC) (IT)

(72) Inventors: Barbara ZONI, Piacenza (IT); Silvio ZONI, Piacenza (IT)

(21) Appl. No.: 16/618,395

(22) PCT Filed: May 30, 2018
(86) PCT No.: PCT/IT2018/050096

§ 371 Date: Dec. 2, 2019

(30) Foreign Application Priority Data
May 30, 2017 (IT) 102017000059162
May 29, 2018 (IT) 102018000005825

(51) Int. Cl. G09F 3/02

(52) U.S. Cl. CPC G09F 3/02; G09F 2003/027; G09F 2003/0257; G09F 2003/0208; G09F 2003/0273

(57) ABSTRACT

A self-adhesive label and a method of its fabrication comprising a pre-punched handle that can be turned in order to hang an object onto which said label can be stuck, characterized by the fact that said label is constituted of the following four layers in the following order: a) a support layer with a silicone varnish (5), b) a layer of adhesive (4), c) a layer of plastic material that constitutes the label (1), d) a further layer of silicone-base varnish (3) applied under the area where the handle is pre-punched, between the adhesive layer (4) and the plastic material (1) of which the label is made, and that said further layer of silicone-based varnish (3) has a force of release from the layer of adhesive (4) that is greater than the force of release of the silicone varnish that covers the support layer.

### TECHNICAL FIELD

The present invention regards a self-adhesive label, which comprises a raisable handle to permit the object to be gripped or hung onto what the same label is attached to, and a method of construction that utilizes basic materials and this permits the lowering of production costs and the reduction of environmental impact.

### STATE OF THE ART

The use of labels that can be used as handles has been addressed by other authors. EP1967457 is one of these examples. EP1967457 describes a adhesive label and hanging handle construction, in particular for medical vessels, comprising a base body, defining a handle, which can be raised to hang a vessel said label is applied to. The label and handle construction is characterized in that it comprises a layered adhesivized material, having a portion, at a raisable part of the handle to which an anti-adhesive substance is applied. The handle portion to be raised from the bottom body, is de-adhesivized according to a particular criterion, to prevent water from penetrating the label through a cut performed by a cutting die.

A part that defines the countour of the handle is not treated with anti-adhesive varnish.

Furthermore, to avoid the handle raising during the manipulation to attach it, for example, to a medicine bottle, said handle has uncut micro-dots to make it remain attached to the base of the body of the label.

One such solution is described in EP1967457 and has a number of disadvantages.

The contour of the handle results as soiled with adhesive, which in the health field can be a vehicle for infections. Furthermore, the handle with the anti-adhesive varnish becomes stiffer and tends to break off. The handle has uncut micro-dots that at the moment of detachment can trigger points of breakage of the handle, which does not have a well-defined cut and therefore a stable part and a well-defined and constant resistance to breakage.

A further disadvantage of the solution proposed in EP19677457 is the necessity of using a coupled layered material for the construction of the label, which causes considerable cost and impedes the use of such labels on low-priced products. Furthermore, the use of coupled materials has a greater environmental impact, in that recycling them becomes more difficult.

Another example of a self-adhesive label with a handle for hanging the object onto which it is applied is given in U.S. Pat. No. 5,829,788A.

U.S. Pat. No. 5,829,788A describes a self-adhesive label comprising a first layer that constitutes the label and a second base layer. On the first layer a handle is pre-punched, which can be turned to hang an object onto which the label can be attached, on the first layer a layer of adhesive is spread and, between the layer of adhesive of the first layer that constitutes the label and the second base layer a layer of facilitated-release varnish is spread, for example a silicone-based varnish. Below the area in which the handle is pre-punched another layer of silicone-based varnish is applied, to facilitate the release of the pre-punched part.

The label described in U.S. Pat. No. 5,829,788A has a number of disadvantages in that, if the further layer of silicone-based varnish remains on the second base layer, when the label is peeled away from the base layer, all the label will be covered with adhesive and, when the label is attached to a bottle or to another object, it will be difficult to detach the pre-punched part of said bottle or other object.

If, however, the further layer of silicone-based varnish remains on the layer of adhesive when the label is peeled away from the second base layer and is made to adhere to a bottle or another object, the pre-punched handle will have no adhesive and will remain free, with the risk of breaking during the operations of boxing or other handling movements.

WO92/15081-A describes a self-adhesive label 10, comprising a pre-punched handle 30, constituted of:
a) a siliconed layer of support 20, that protects
b) a first adhesive layer 18, until the label is attached to a bottle;
c) a base layer of acetate film 14;
d) two layers of printing ink 22 and 24;
e) a second layer of adhesive 26 is applied to the layers of printing ink 22 and 24 to bind them;
f) a layer of transparent film 28, which forms the frontal surface 12 of the label 10,
g) A layer of silicone varnish 36 is applied between the layer of ink 22 and the base layer of acetate film 14.

The handle is punched through the frontal surface 12 of the label, along the lines 32 and 34. Both the lines 32 and 34 penetrate the layer of transparent film 28, the second layer of adhesive 26, and the two layers of printing ink 22 and 24. The layer of silicone-based varnish binds to the layer of printing ink but does not adhere to the frontal surface 15 of the acetate film 14.

WO92/15081-A has the following disadvantages:
a) the silicone varnish 36, not being associated to an adhesive, does not maintain the pre-punched handle 30 stuck to the acetate film 14, and therefore the handle remains free and runs the risk of being broken during the operations of boxing and/or other operations of handling movement;
b) When the handle is peeled from the layer of acetate film it presents said second layer of adhesive 26 covered only by the layers of printing ink and silicone, so the possibility that the operator will soil his hands with the adhesive 26 remains high.

### SUMMARY OF THE INVENTION

The present invention proposes to overcome the disadvantages present in the State of the Art to create a label provided with a handle to be gripped or to hang the object onto which it is attached.

A principal aim of the present invention is to create a label comprising a raisable handle that does not present traces of adhesive, that has a precise cut capable of guaranteeing its breaking point with precision.

Said aim is reached by creating a self-adhesive label comprising a pre-punched handle that can be turned in order to hang an object onto which said label can be stuck, characterized by the fact that said label is constituted of the following four layers in the following order: a) a support layer of silicone, b) a layer of adhesive, c) a layer of plastic material that constitutes the label, d) a further layer of silicone-base varnish applied under the area where the handle is pre-punched, between the adhesive layer and the plastic material of which the label is made, and that said further layer of silicone-based varnish has a force of release from the layer of adhesive that is greater than the force of release of the silicone varnish that covers the support layer.

A label created as above described reaches the aims of the present invention, a) when the label is separated from the silicone layer of support it has the adhesive distributed over all its surface, b) when the pre-punched handle is peeled away, turned and detached from the label there is no residue of adhesive on it and the operator does not risk soiling his hands with the adhesive that could have stuck to his hands, c) the handle has the same rigidity as the material of which the label is made, in that it is not covered by other layers of varnish.

Another aim of the present invention is reached with a further layer of print with information and/or data regarding the product on a surface of the layer of plastic material that constitutes the label and that in turning the handle said information and/or data remains adhered to the object onto which the label is stuck.

A further aim of the present invention is to create a method of construction that utilizes basic materials and the production of said label is therefore of low cost. Furthermore, another aim of the present invention is to produce a label that has the handle well-adhered to the label until the moment of its peeling away. The layer of silicone-based varnish is spread between the adhesive layer and the plastic material of which the label is made, precisely below the area where the handle is pre-punched. The application of the further layer of silicone-based varnish above the adhesive but below the material of which the label is made produces said advantage that is not the only one.

Said further aim is reached by creating a method of constructing a self-adhesive label comprising a pre-punched handle that can be peeled away, turned and detached in order to hang an object onto which said label can be stuck, said method foresees the following materials:
a) A first spool containing a support layer already covered with a silicone-based varnish or that is covered with a silicone-based varnish;
b) a second spool containing the plastic material that constitutes the label;
   said first and second spools are unravelled separately and while they are being unravelled said method foresees the following steps, in the following order:
A. On the silicone-based varnish of the first spool a layer of adhesive or self-adhesive glue is spread;
B. The lower or upper surface of the plastic material of the second spool that constitutes the label can be printed on;
C. On the surface of the plastic material of the second spool that constitutes the label and that comes into contact with the layer of adhesive of the first spool, a further layer of silicone-based varnish is spread on the area that constitutes the handle;
D. The further layer of silicone-based varnish that comes into contact with the layer of adhesive of the first spool has a force of detachment from the upper layer of adhesive that is greater than that of the silicone-based varnish that covers the siliconed support layer;
E. The support layer covered by silicone-based varnish and by adhesive of the first spool is united to the plastic material that constitutes the label of the second spool, furnished with a further layer of silicone-based varnish on the area that constitutes the handle.
F. The plastic material of the second spool, that constitutes the label, is punched with a punch that has the shape of the handle that is desired to be made.

The method given of the present invention has the aim of obtaining a reduction in the use of materials in as much as the layers used are fewer to those foreseen in the previous state of the art, all of which produces a notable advantage both in terms of costs and in time, all to the advantage of the environment because of the lower consumption of materials and energy and production of waste.

Other advantages and characteristics will be clear from the illustrations given as non-limiting examples in the FIGS. 1,2,3,4,5,6, and 7.

### A BRIEF DESCRIPTION OF THE FIGURES

FIG. 1 shows the view of a label comprising a handle that conforms to the present invention when said handle is still attached to the layer of siliconed support.

FIG. 2 shows the section of a label comprising a handle that conforms to the present invention when it is still attached to an already siliconed layer of support.

FIG. 3 shows the view of a label comprising a handle that conforms to the present invention, attached to a bottle.

FIG. 4 shows the section of a label comprising a handle that conforms to the present invention, attached to a bottle.

FIG. 5 shows the section of a label comprising a handle that conforms to the present invention when it is still attached to an already siliconed layer of support, that is covered by a further layer of print with information and/or data.

FIG. 6 shows the view of a label comprising a handle that conforms to the present invention, attached to a bottle, with information and/or data stamped on it.

FIG. 7 shows the section of a label comprising a handle that conforms to the present invention, attached to a bottle, with information and/or data printed on it.

### A DESCRIPTION OF A PREFERRED EMBODIMENT OF THE INVENTION

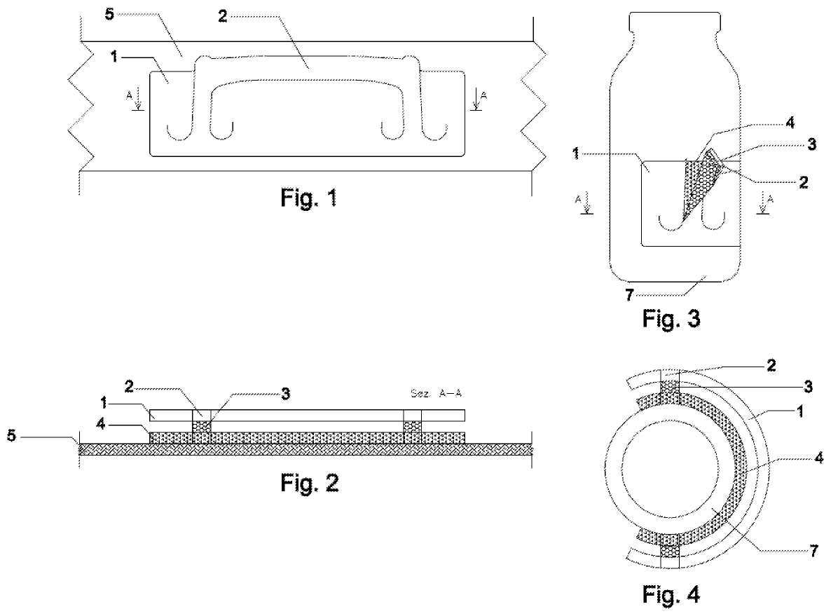

With reference to FIG. 1, the label 1 shows a pre-punched handle 2, that can be turned by raising it.

With reference to FIG. 2, the self-adhesive label 1 comprises a handle 2 that is pre-punched onto the same label 1 and that can be peeled away, turned and detached in order to grip it or hang an object onto which said label can be stuck. Said label is, in the following order, constituted of four layers: a) a siliconed layer of support 5, said layer of support 5 can be of paper or of other material, b) a layer of adhesive 4, c) a further layer 3 of silicone-based varnish between the layer of adhesive 4 and the pre-punched part of the label 2 that forms the handle, d) the label in itself 1, of plastic material, for example. The further silicone-based varnish 3, which is applied between the surface of the label 1 where the handle 2 is pre-punched and the layer of adhesive 4, has a force of detachment from the layer of adhesive that is greater than that of the silicone-based varnish that covers the layer of support 5.

In the phase of labelling the label 1 is dispensed by detaching it from the layer of support 5 covered by the silicone-based varnish, the adhesive layer 4 remains attached both to the label 1 and to the handle 2, in that the handle 2, although pre-punched, remains well-adhered to the adhesive layer 4 because the silicone-based varnish 3 has a force of detachment from the adhesive layer 4 greater than that of the support layer 5 covered with silicone-based varnish.

With reference to FIGS. 2, 3 and 4, when the label 1 is applied to an object 7, said label 1 is completely covered with adhesive and therefore all the label is well stuck to the object 7 onto which it is applied.

Once the label 1 has been applied, the handle 2 can be peeled away, turned and detached in that the force of detachment of the layer of adhesive of the silicone-based varnish 3 is notably inferior to the force of adhesion of the adhesive layer 4 to the object 7. Once the handle 2 of the label 1 has been peeled away, turned and detached, it does not present traces of the adhesive 4 that remains on the body of the object 7 and the operator who has to take hold of the handle 2 does not soil himself. The detachment of the handle is precise and follows the line of punches and there are no uncut micro-dots that might lead to the breakage of the handle causing a diminution of its load-bearing ability.

The present label can be applied to any object and by turning the handle any object can easily be held to be lifted, hung or transported. Said label may, however, have a specific use with pharmaceuticals, in that said handle of said label does not present traces of adhesive and can preferably hang bottles of pharmaceuticals, for carrying out drips for example. The handle will not be dirtied by glue which could soil the hands of the operator, as happens with the other labels currently on sale.

The method of construction of the label 1 conforms to a method of creation of the invention that is simple and permits the construction of labels that have advantages that other labels furnished with handles do not permit. A further advantage of the method of construction is the use of simple and non-composite materials and therefore prime materials with a lower cost compared to those used by the competition and with a lower impact on the environment.

The method foresees the following materials:
a) A first spool containing a support layer covered with silicone-based varnish or that is covered in silicone-based varnish
b) a second spool containing the plastic material that constitutes the label;
   said first and second spools are unravelled separately and while they are being unravelled said method foresees the following steps, in the following order:
A. On the silicone-based varnish of the first spool a layer of adhesive is spread;
B. On the surface of the plastic material of the second spool, that constitutes the label and that comes into contact with the layer of adhesive of the first spool, a further layer of silicone-based varnish is spread on the area that constitutes the handle;
C. The further layer of silicone-based varnish that comes into contact with the layer of adhesive of the first spool has a force of detachment from the layer of adhesive that is greater than that of the silicone-based varnish that covers the support layer;
D. The support layer covered in silicone-based varnish and of adhesive of the first spool is united to the plastic material that constitutes the label of the second spool, which is furnished with a further layer of silicone-based varnish on the area that constitutes the handle.
E. The plastic material of the second spool, that constitutes the label, is punched with a punch that has the shape of the handle that is desired to be constructed.

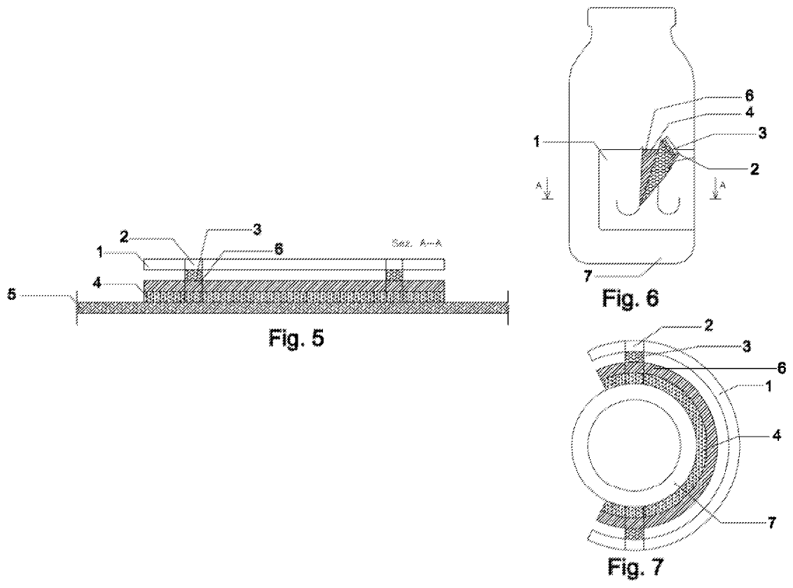

With reference to the FIGS. 5, 6 and 7, another method of construction of the invention is illustrated.

With reference to FIG. 5, the self-adhesive label 1 comprises a handle 2 that is pre-punched on the same label 1 and that can be peeled away, turned and detached in order to grip it or hang an object onto which said label can be stuck.

Said label is, in the following order, constituted of: a) a silicone-covered support layer 5, said support layer 5 can be of paper or of other material, b) a layer of adhesive or self-adhesive glue 4, c) a further layer of silicone-based varnish 3 between the layer of adhesive 4 and the pre-punched part of the label 2 that forms the handle, d) the label 1 in itself, for example in a plastic material, e) the print of data 6 made on the upper surface of the label 1 or on the lower surface of the label 1 is furnished with a further layer of silicone-based varnish 3. Under the surface of the label 1 where the handle 2 is pre-punched, a further layer of silicone-based varnish is applied. The further silicone-based varnish 3 has a force of detachment from the layer of adhesive 4 that is greater than that of the silicone-based varnish that covers the support layer 5.

During the phase of labelling the label 1 is dispensed by detaching it from the layer of support 5 covered in silicone-based varnish, the adhesive layer 4 remains attached to both the label 1 and to the handle 2, in that the handle 2, although pre-punched, remains well-attached to the adhesive layer 4 because the silicone-based varnish 3 has a force of detachment from the adhesive 4 that is greater than that of the support layer 5 covered in silicone-based varnish.

With reference to FIGS. 5, 6 and 7, when the label 1 is applied to an object 7, said label 1 is completely covered in adhesive and therefore all the label is well stuck to the object 7 onto which it is applied.

Once the label 1 has been applied, the handle 2 can be peeled away, turned and detached, in that the force of detachment of the layer of adhesive of the silicone-based varnish is notably inferior to the force of adhesion of the adhesive layer 4 on the object 7. The handle 2 of the label 1, once peeled away, turned and detached does not present traces of the adhesive 4 that remains on the body of the object 7 and the operator who has to take hold of the handle 2 does not soil himself. The detachment of the handle is precise and follows the line of punching and there are no uncut micro-dots that might lead to the breakage of the handle causing a diminution of its load-bearing ability. The printing 6, carried out on the surface of the label remains on the label, and if the printing 6 is carried out on the lower surface of the label 1 already furnished with the silicone-based varnish 3, all the print remains attached to the object even after detaching the handle following the lines of punching, with the effect of a transparency.

The present label can be applied to any object and by turning the handle any object can easily be held to be raised, hung or transported. Said label has, however, a specific use for pharmaceuticals, in that said handle of said label does not present traces of adhesive and can preferably be use to hang bottles of pharmaceuticals, for carrying out drips for example. The handle will not be dirty with glue that could, with the other labels currently on sale, soil the hands of the operator.

With reference to FIGS. 5 6 and 7.

The method of construction of the label 1 conforms to a method of creating the invention that results as simple and permits the construction of labels that present advantages that other labels furnished with handles do not permit. A further advantage of the method of construction is the use of simple and non-composite materials and therefore prime materials with a lower cost compared to those used by the competition and with a lower impact on the environment.

A further advantage is obtained in the case of printing 6 on the lower part of the label 1, in that the print results as protected by the material of the label 1 and is not subject to scratches, abrasions or removal due to contact with chemical agents.

The method foresees the following materials
a) A first spool containing a support layer 5 covered in silicone-based varnish or that is covered in silicone-based varnish;
b) A second spool containing a transparent plastic material that constitutes the label 1;
said first and second spools are unravelled separately and while they are being unravelled said method foresees the following steps, in the following order:
A. On the silicone-based varnish 5 of the first spool a layer of adhesive 4 is spread;
B. On the surface of the plastic material of the second spool that constitutes the label and that comes into contact with the layer of adhesive 4 of the first spool, a further layer of silicone based varnish 3 is spread on the area that constitutes the handle 2;
C. The lower surface of the transparent plastic material of the second spool that constitutes the label 1, already covered in a further layer of silicone-based varnish 3, can be printed on;
D. The further layer of silicone-based varnish that comes into contact with the layer of adhesive of the first spool has a force of detachment of the layer of adhesive that is greater than that of the silicone-based varnish that covers the support layer;
E. The support layer covered in silicone-based varnish and adhesive of the first spool is united to the plastic material of the second spool that constitutes the label, which is furnished with a further layer of silicone-based varnish on the area that constitutes the handle.
F. The plastic material of the second spool that constitutes the label is punched with a punch that has the shape of the handle that is desired to be constructed.

The discovery, it is well understood, is not limited to the representations given by the illustrations but may be modified and perfected by those skilled in the art without exceeding the limits of patent.

The present invention permits numerous advantages and to overcome difficulties that could not be overcome with the systems currently on sale.

1. A self-adhesive label comprising a pre-punched handle that can be turned in order to hang an object onto which said label can be stuck, characterized by the fact that said label is constituted of the following four layers in the following order: a) a support layer with a silicone varnish (5), b) a layer of adhesive (4), c) a layer of plastic material that constitutes the label (1), d) a further layer of silicone-base varnish (3) applied under the area where the handle is pre-punched, between the adhesive layer (4) and the plastic material (1) of which the label is made, and that said further layer of silicone-based varnish (3) has a force of release from the layer of adhesive (4) that is greater than the force of release of the silicone varnish that covers the support layer.

2. A self-adhesive label according to claim 1 characterized by the fact that the lower or superior surface of the plastic material that constitutes the label (1) presents a further layer of print with information and/or data.

3. A self-adhesive label according to claim 1 characterized by the fact that the plastic material that constitutes the label (1) is transparent and that the lower surface of the plastic material that constitutes the label (1) already provided with the further layer of silicone varnish (3) presents printed information or data.

4. A method of fabrication of a self-adhesive label comprising a pre-punched handle that can be peeled away, turned and detached in order to hang an object onto which said label can be stuck, characterized by the fact that said method foresees the following materials:
c) A first spool containing a support layer already covered with a silicone-based varnish or that is covered with a silicone-based varnish;
d) a second spool containing the plastic material that constitutes the label;
said first and second spools are unravelled separately and while they are being unravelled said method foresees the following steps, in the following order:
G. On the silicone-based varnish of the first spool a layer of adhesive or self-adhesive glue is spread;
H. On the surface of the plastic material of the second spool that constitutes the label and that comes into contact with the layer of adhesive of the first spool, a further layer of silicone-based varnish is spread on the area that constitutes the handle;
I. The further layer of silicone-based varnish that comes into contact with the layer of adhesive of the first spool has a force of detachment from the upper layer of adhesive that is greater than that of the silicone-based varnish that covers the siliconed support layer;
J. The support layer covered by silicone-based varnish and by adhesive of the first spool is united to the plastic material that constitutes the label of the second spool, furnished with a further layer of silicone-based varnish on the area that constitutes the handle;
K. The plastic material of the second spool, that constitutes the label, is punched with a punch that has the shape of the handle that is desired to be made.

5. A method of fabrication of a self-adhesive label according to claim 4 characterized by the fact that the lower or superior surface of the plastic material that constitutes the label (1) is covered with a further layer of print with information and/or data.

6. A method of fabrication of a self-adhesive label according to claim 4 characterized by the fact that that the plastic material that constitutes the label (1) is transparent and that on the lower surface of the plastic material that constitutes the label (1) already provided with the further layer of silicone varnish (3) information or data are printed.
